(19) United States
(12) Patent Application Publication
(10) Pub. No.: US 2014/0359452 A1
(43) Pub. Date: Dec. 4, 2014

(54) Systems, Methods, And Computer-Readable Media Related To Presentation Software

(71) Applicant: Exhibit View Solutions LLC, Rome, GA (US)

(72) Inventors: William V. Roach, Grayson, GA (US); Robert K. Finnell, Rome, GA (US)

(73) Assignee: Exhibit View Solutions LLC, Rome, GA (US)

(21) Appl. No.: 14/460,864

(22) Filed: Aug. 15, 2014

Related U.S. Application Data
(63) Continuation of application No. 11/940,376, filed on Nov. 15, 2007, now abandoned.

(51) Int. Cl. G06F 3/0481

(52) U.S. Cl. CPC G06F 3/04817; G06F 3/0481
USPC 715/730

(57) ABSTRACT

An inventive presentation software, preferably for use on a portable computer, is disclosed. In one embodiment, the presentation software automatically detects whether a projector is connected to the portable computer, and automatically outputs to the projector only a predefined portion of the computer screen. In another embodiment, the presentation software permits a user to control various projector functions (e.g., brightness, contrast, etc.) from within the presentation software itself.

### CROSS REFERENCE TO RELATED APPLICATIONS

This application claims the benefit of U.S. provisional patent application Ser. No. 60/865,858, filed on Nov. 15, 2006, having the title “Exhibit View,” which is incorporated herein by reference in its entirety.

This application also claims the benefit of U.S. provisional patent application Ser. No. 60/938,301, filed on May 16, 2007, having the title “Electronic Executive Letter,” which is incorporated herein by reference in its entirety.

### FIELD OF THE INVENTION

The present disclosure relates generally to software and, more particularly, to presentation software.

### BACKGROUND

Currently, Microsoft® Corporation (“MSFT”) sells presentation software called PowerPoint® (“PPT”). Specifically, PPT permits a user to prepare presentations in the form of slides or handouts, among other things. Once slides are prepared using PPT, the user can also use PPT to present the prepared slides to, say, an audience.

Despite the presentation options available in PPT, or other similar software that is currently available on the market, the functionality available in PPT is somewhat limited for some specific uses.

Thus, for example, in the legal field, another presentation software called Trial Director™ (“TD”) exists, which provides increased functionality to users that are specific to the legal field. Unfortunately, TD's functionality is somewhat cumbersome and non-intuitive. As such, TD offers courses and specialized training to educate the end-user on how to efficiently use many or all of TD's functions.

In view of these deficiencies in the industry, there exists an unaddressed need.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an embodiment of a graphical user interface (“GUI”) for displaying slides in one embodiment of the inventive presentation software.

FIG. 2 shows an embodiment of a GUI for creating slides in the presentation software.

FIG. 3 shows an embodiment of a GUI creating slides from a template.

FIG. 4 shows an embodiment of a GUI for displaying documents in the presentation software.

FIG. 5 shows an embodiment of a GUI where a user can select different types of electronic files.

FIG. 6 shows an embodiment of a GUI where a document has been selected for display on one half of a screen.

FIG. 7 shows an embodiment of a GUI where a document and an image have been selected for simultaneous display, each on its respective half of the screen.

FIG. 8 shows an embodiment of a GUI where an image has been selected for display on the full screen.

FIG. 9 shows an embodiment of a GUI where a video has been selected for display on the full screen.

FIG. 10 shows an embodiment of a GUI where a selected portion of a document is enlarged for display.

FIG. 11 shows an embodiment of a GUI where a selected portion of a document is highlighted.

FIG. 12 shows an embodiment of a GUI where a portion of a document is underlined.

FIG. 13 shows an embodiment of a GUI where a selected portion of a document is circled.

FIG. 14 shows an embodiment of a GUI where two separate documents have been selected for display on a split screen, where one side of the split screen is larger than the other side of the split screen.

FIG. 15 shows another embodiment of a GUI where the split screen is larger on one side than it is on the other side.

FIG. 16 shows an embodiment of a GUI with a web browser located within the presentation software.

FIG. 17 shows an embodiment of a GUI where a web page can be saved to a file for later display.

FIG. 18 shows an embodiment of presentation software having control functions for a projector that are accessible from within the presentation software.

FIG. 19 shows an embodiment of presentation software configured to permit email access from within the presentation software.

FIG. 20 shows an embodiment of the presentation software of FIG. 19, in which a user has accessed his email account from within the presentation software.

FIG. 21 shows an embodiment of the presentation software of FIG. 20, which permits a user to directly save an attachment for later display.

FIG. 22 shows an embodiment of software that automatically detects whether a computer is connected to a projector and selectively outputs a predefined portion of the GUI on the computer to the projector for display on a projector screen.

### DEFINITIONS

In an effort to avoid any ambiguity, several terms and phrases are expressly defined herein. For words and phrases that are not expressly defined herein, it is intended that the ordinary dictionary definition apply to those words and phrases.

“Button” and “icon” are used synonymously. “Button” shall mean a graphical user interface (GUI) widget that provides an end-user a mechanism for triggering an event.

“Computer display,” “computer monitor,” and “monitor” are used synonymously unless expressly indicated otherwise. “Monitor” shall mean a piece of electrical equipment which displays viewable images generated by a computer without producing a permanent record. For example, a computer monitor is usually a cathode ray tube or some form of flat panel, such as a thin-film transistor (TFT) liquid-crystal display (LCD). The monitor comprises the display device, circuitry to generate a picture from electronic signals sent by the computer, and an enclosure or case.

“Computer” shall mean any machine which manipulates data according to a list of instructions. Some examples of a computer include desktop computer, laptop computer, hand-held computer, etc.

“Conventional presentation software” shall mean any presentation software that was sold, used, or known prior to the effective filing date of this application. Some examples of conventional presentation software include versions of the following software, which were used and sold prior to the effective filing date of this application: Adobe® Persuasion, AppleWorks, Beamer, Harvard Graphics, MSFT PPT, OpenOffice Impress, Trial Director, and Zoho, among others.

“Graphical user interface” or “GUI” shall mean a user interface that allows a user to interact with a computer or computer-controlled devices which employ graphical icons, visual indicators or special graphical elements, along with text, labels or text navigation to represent the information and actions available to a user. The actions are usually performed through direct manipulation of the graphical elements.

“Menu” shall mean a list of commands presented to an operator or end-user by a computer or communications system.

“Or” shall be used in the inclusive sense, rather than the exclusive sense, unless expressly noted otherwise. Thus, for example, the phrase “text or icon” shall be construed to include “text” alone, “icon” alone, and “text and icon” together.

“Presentation software” (without being modified as “conventional”) shall refer to the inventive presentation software, and various embodiments thereof, which are described and claimed.

“Projector” shall mean a hardware device used for displaying an image on a projection screen or similar surface for the view of an audience.

“Tab” shall mean a navigational widget for switching between two electronic documents or files. Tabs are traditionally designed as a text label within a rectangular box with its top borders rounded. Activating a tab (usually by a mouse click) makes its associated document or file visible and the tab itself usually becomes highlighted to distinguish it from other inactive tabs. Typically, GUI tabs are modeled after traditional card tabs inserted in paper files or card indexes and thus they are often employed to give the user interface a familiar appearance.

“Toolbar” shall mean a row, column, or block of onscreen buttons or icons that, when clicked, activate certain functions of an associated program.

“Window” shall mean a visual area, often rectangular in shape, containing some type of user interface, displaying the output of and allowing input for one of a number of simultaneously running computer processes. Windows are primarily associated with graphical displays, where they can be manipulated with a pointer.

### DETAILED DESCRIPTION OF THE EMBODIMENTS

In order to address some of the above-recited deficiencies in conventional presentation software, the inventive software removes several cumbersome features that currently complicate the use of presentation software. Additionally, for other embodiments, the inventive software adds functionality that improves usability and streamlines the preparation and presentation of slides and various other electronic files.

For example, it is possible to employ a dual-display mode using conventional presentation software (e.g., MSFT PPT), where a given screen is shown on a computer display while a different image is projected to a screen from a projector. However, the conventional software is not intuitive in permitting an end-user to easily employ the dual-display mode. Unlike conventional presentation software, one embodiment of the invention includes computer code that automatically detects whether or not a projector is coupled to a computer. In the event that a projector is coupled to the computer, the code automatically outputs to the projector only a portion of the computer display, while keeping the remainder of the computer display hidden from an audience that is viewing the projector output.

Another shortcoming in conventional systems is that software-based projector control mechanisms are de-coupled from the presentation software itself. As such, during the middle of a presentation, should the end-user wish to adjust the brightness or contrast of the projector output, there is no simple mechanism for doing so without closing the presentation software and interrupting the presentation. One embodiment of the invention seeks to remedy this problem by coupling the projector control mechanism with the presentation software itself. Thus, should an end-user seek to adjust the projector output during the presentation, the end-user can simply open a projector control toolbar from within the presentation itself, and seamlessly adjust the projector output without interrupting the flow of the presentation.

These, and other, advantages are described in detail, referring to the drawings. While several embodiments are described in connection with these drawings, there is no intent to limit the invention to the embodiment or embodiments disclosed herein. On the contrary, the intent is to cover all alternatives, modifications, and equivalents.

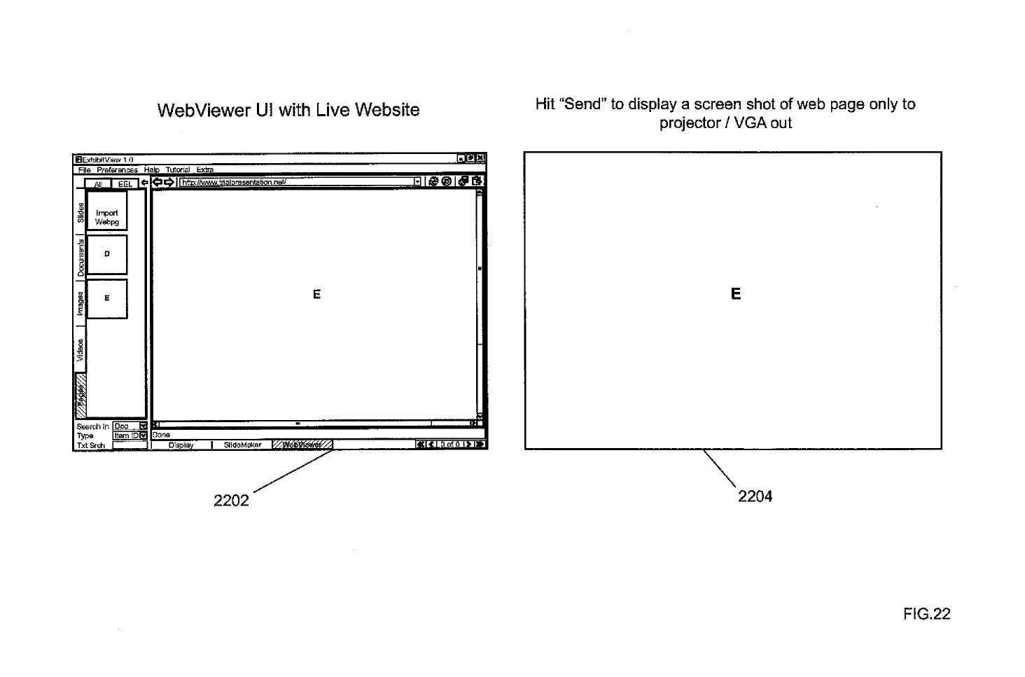

FIG. 22 shows an embodiment of software that automatically detects whether a computer is connected to a projector and selectively outputs a predefined portion of the GUI on the computer to the projector for display on a projector screen. In the embodiment of FIG. 22, the presentation software comprises machine-readable code for displaying a graphical user interface (GUI) 2202 on a computer monitor. The GUI 2202 comprises two distinct sections. Namely, a display window and a functional area. The display window shows only the portion of the GUI that will be output to the projector, illustrated in FIG. 22 as 2204. As such, irrespective of what the user or operator is doing in the functional area of the GUI 2202, as long as the display window remains unchanged, the projector output 2204 will remain unchanged.

The presentation software, in a preferred embodiment, also comprises machine-readable detection code for detecting whether a projector is coupled to a computer. Should the software detect that a projector is coupled to the computer, then the software outputs only the display window portion 2204 of the entire GUI 2202 to the projector. In order to accomplish this, the software also includes machine-readable output code that outputs the predefined display area 2204 of the GUI 2202 to the projector when the presence of a projector is detected. Since plug-and-play devices are known in the art, further discussion of how the presence of the projector is determined is omitted herein.

For some embodiments, the presentation software will also determine the type of output device that is coupled to a secondary VGA output of a computer. As such, the presentation software can determine whether the secondary VGA output is coupled to another computer display monitor or a projector or another type of output device. As such, the primary computer display will show the full GUI while only the display window will be output to the secondary VGA. It should be appreciated that, should a user or operator so desire, the presentation software can also be configured to output the entire GUI (rather than just the display window) to the secondary VGA output.

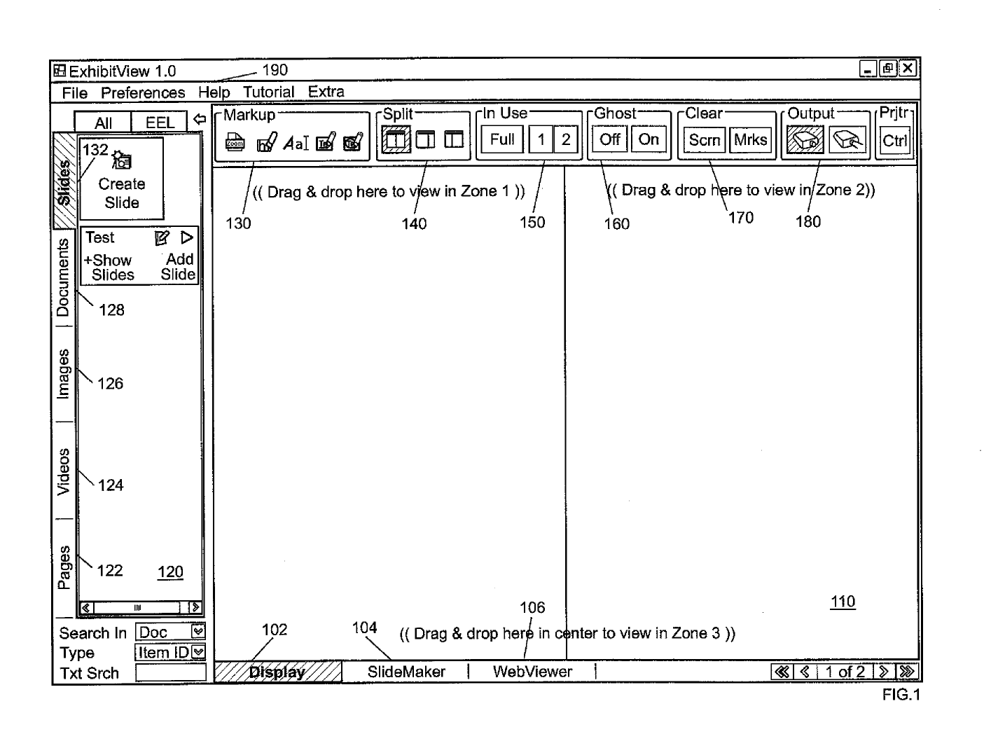

Continuing, FIG. 1 shows an embodiment of presentation software with a graphical user interface (“GUI”) for displaying slides. In the embodiment of FIG. 1, the GUI comprises a display window 110 in which various electronic documents or files can be displayed. As described with reference to FIG. 22, when a projector is operatively coupled to the computer, the full GUI 2202 is shown on the computer monitor while only the display window 110 is output to the projector (see 2204, FIG. 22).

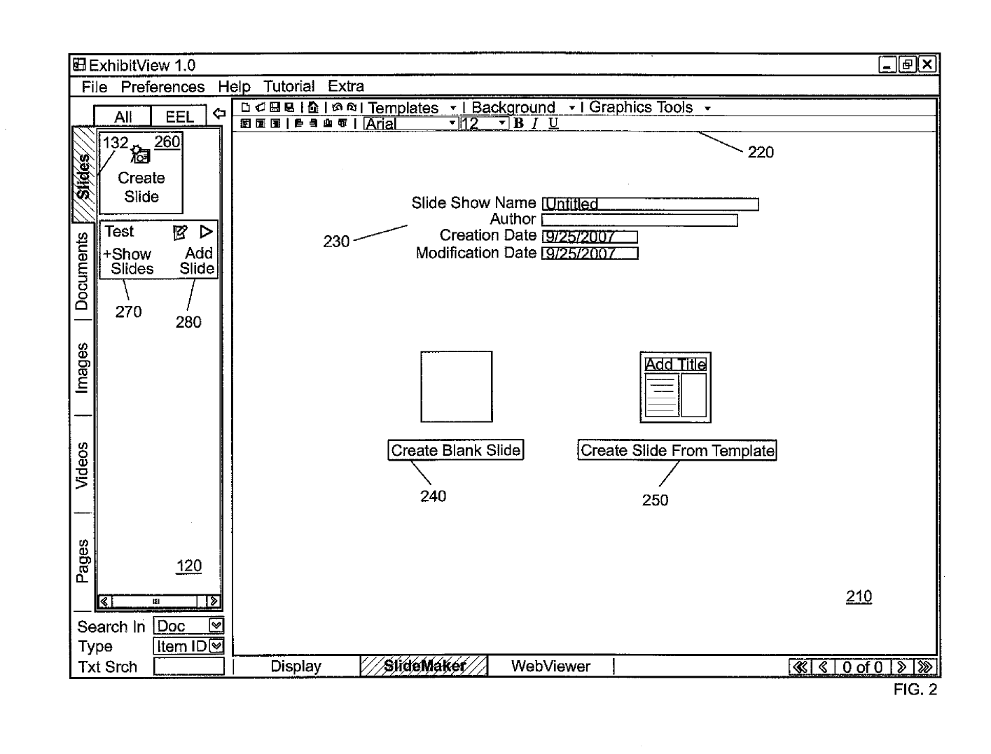

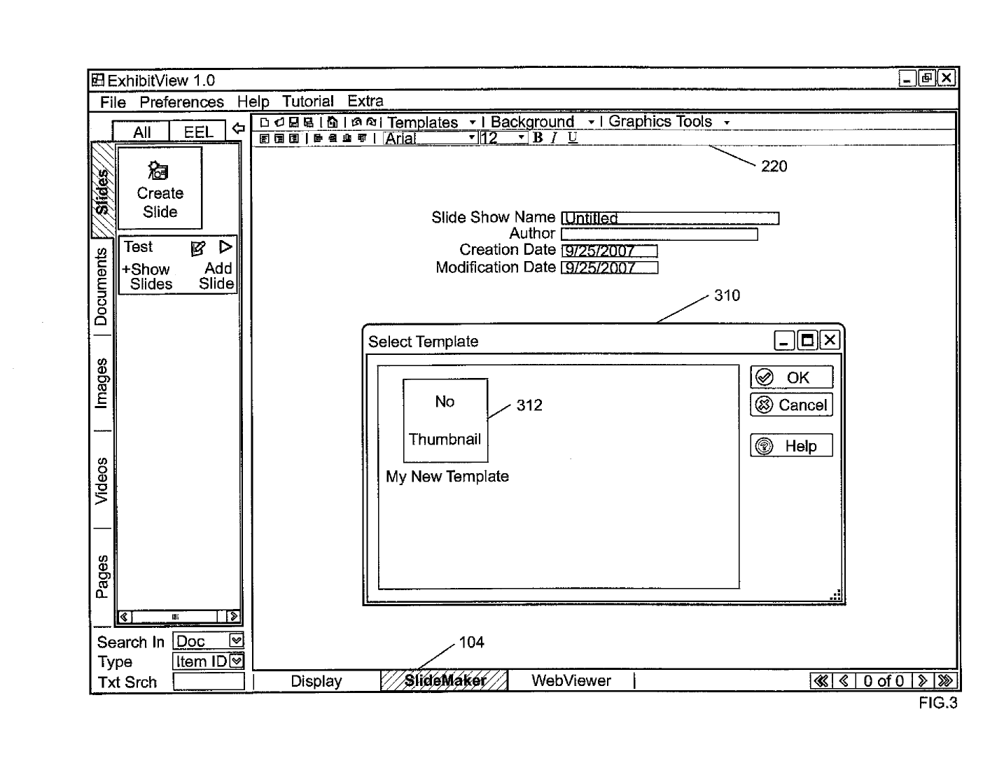

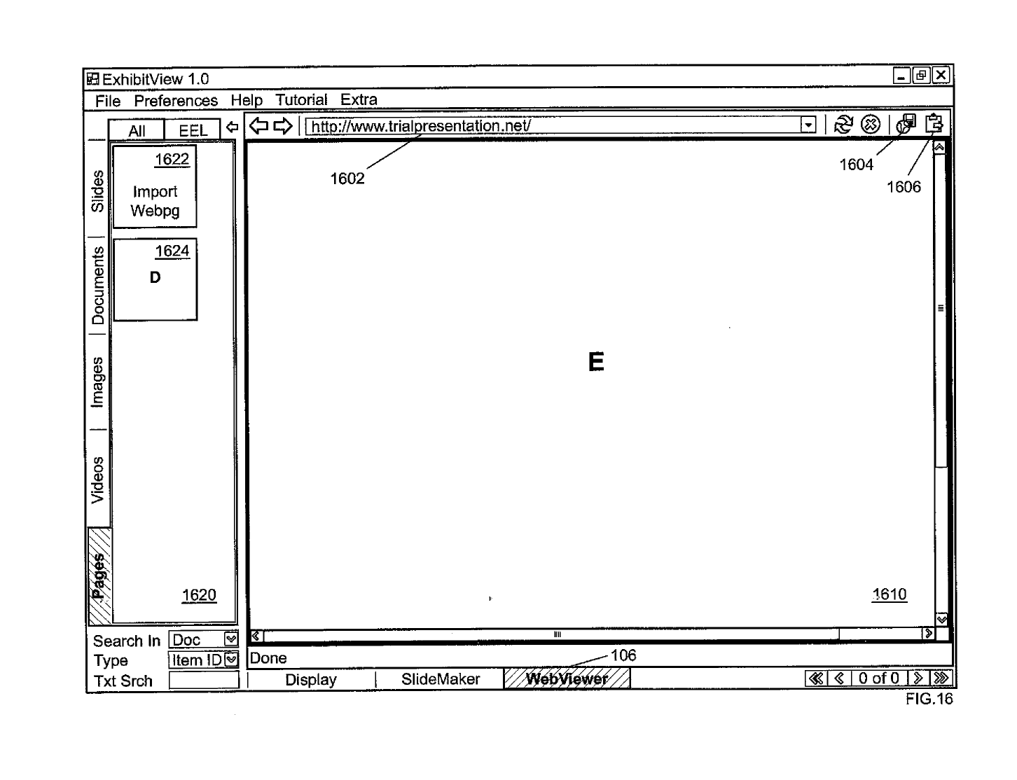

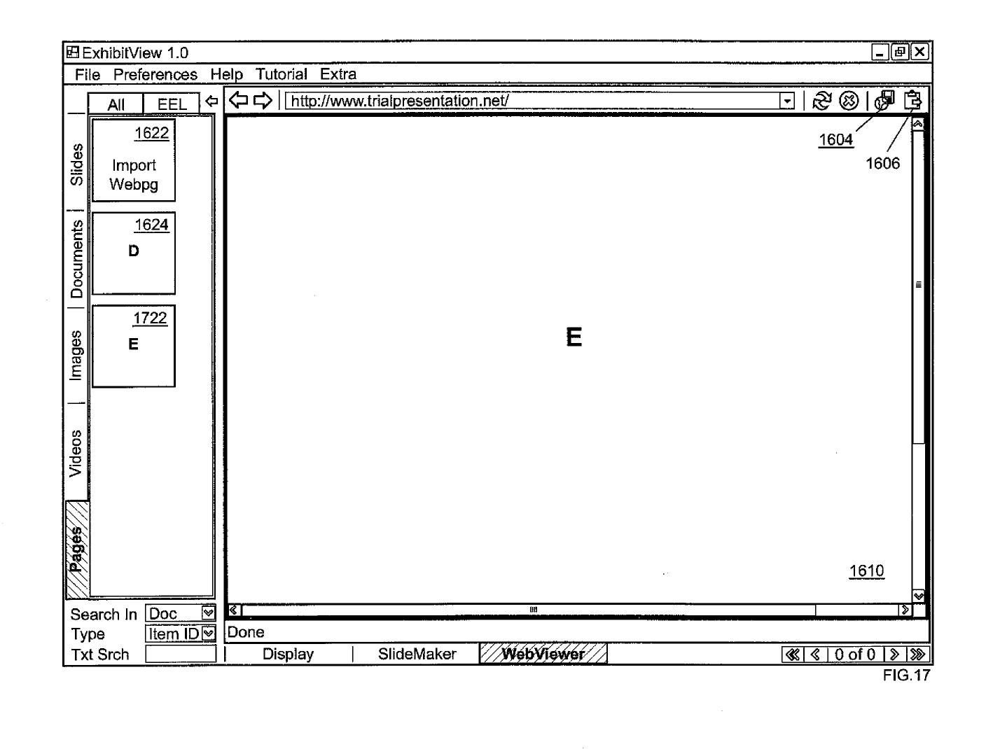

The GUI also comprises a display tab 102, a slide-maker tab 104, and a web-browser tab 106. The display tab 102, when selected by the operator or user, shows on the display window 110 the electronic documents or files that has been placed in the display window 110 by the operator or user. The placement of electronic documents or files in the display window 110 is described in greater detail below. The slide-maker tab 104 is described in greater detail with reference to FIGS. 2 and 3 and throughout the remainder of the detailed description. The web-browser tab 106 is described in greater detail with reference to FIGS. 16 and 17 and throughout the remainder of the detailed description.

In the embodiment of FIG. 1, the GUI further comprises several tabs that are associated with various file types. Each tab comprises a list of electronic documents or files, such as, for example, a web-page tab 122, a video tab 124, an image tab 126, a document tab 128, and a slide tab 132. By way of example, the slide tab 132, when selected by the operator or user, brings to the foreground a slide listing window 120, which includes various icons (described below). Similarly, selection of any of the other tabs 122, 124, 126, 128 will bring to the foreground its corresponding window. Various examples associated with these tabs are described in greater detail below.

The embodiment of FIG. 1 also includes several toolbars, such as, for example, a markup toolbar 130, a split-screen toolbar 140, an in-use indicator toolbar 150, a pointer toolbar 160, a projector output toolbar 180, and a toolbar 170 for other functions that an operator or user may wish to implement.

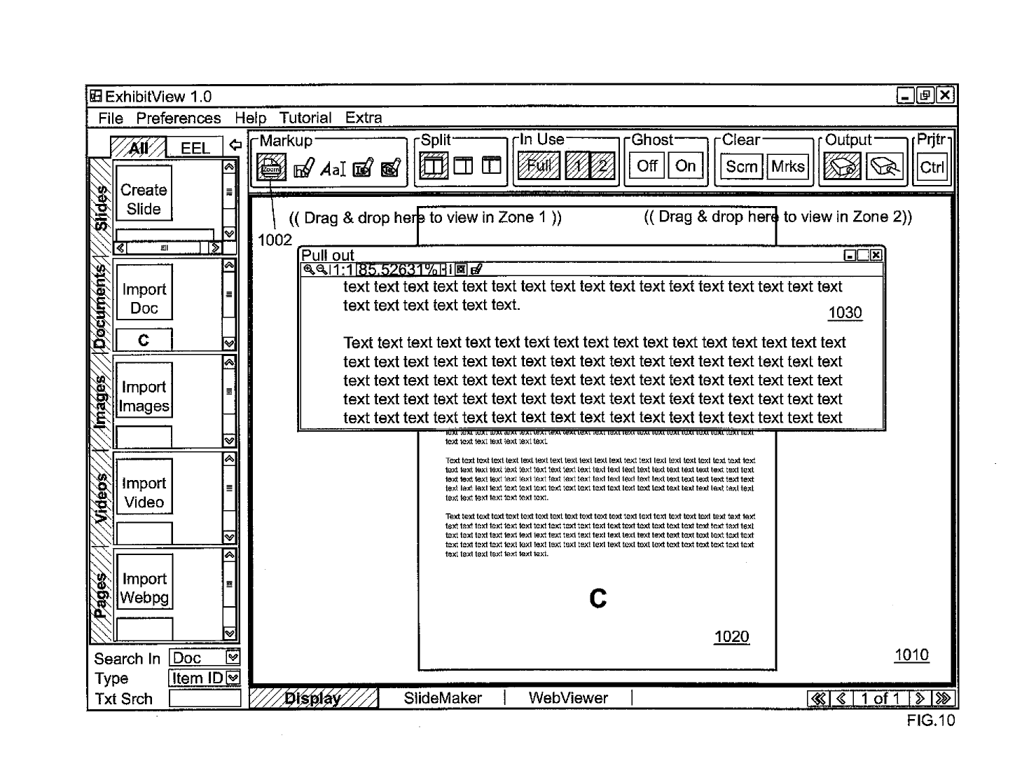

The markup toolbar 130, in the embodiment of FIG. 1, includes various icons that permit an operator or user to emphasize various portions of the displayed document or file. The miscellaneous toolbar 170, in the embodiment of FIG. 1, shows two icons (described below) for clearing any markup or removing displayed items from the screen. Several examples of functions associated with the markup toolbar 130 and the miscellaneous toolbar 170 are described in greater detail with reference to FIGS. 10, 11, 12, and 13.

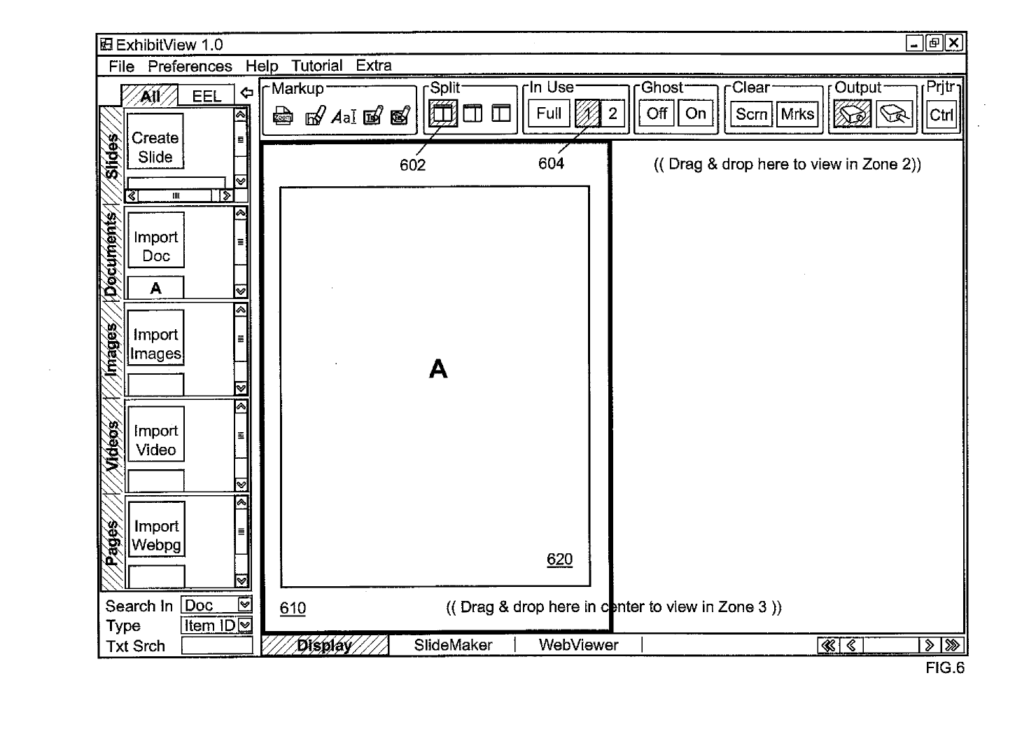

The split-screen toolbar 140, in the embodiment of FIG. 1, includes various icons that permit the user or operator to concurrently display multiple documents or files in the display area 110. Several examples of functions associated with the split-screen toolbar 140 are described in greater detail with reference to FIGS. 6, 7, 14, and 15.

The in-use indicator toolbar 150, in the embodiment of FIG. 1, shows which portion of the display window 110 is being used at any given time. The in-use indicator toolbar 150 is described in greater detail with reference to FIGS. 6, 7, 8, 14, and 15.

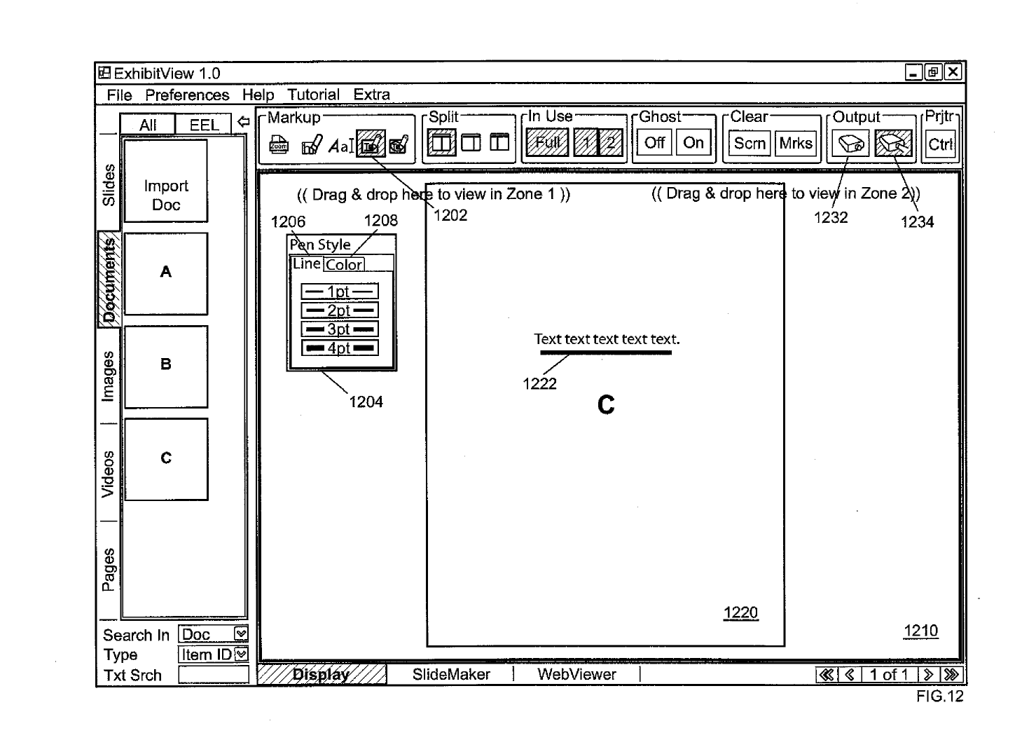

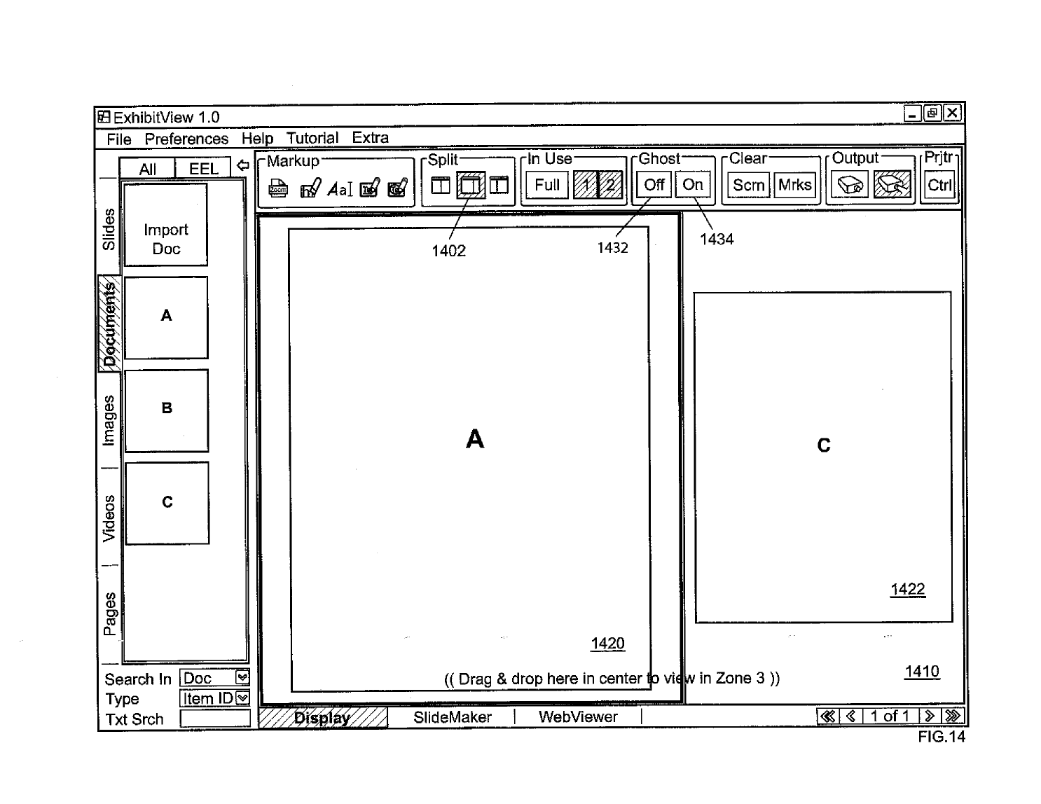

The pointer toolbar 160 is described in greater detail with reference to FIG. 14, and the projector output toolbar 180 is described in greater detail with reference to FIG. 12.

As shown in FIG. 1, the GUI can also include a standard menu bar 190, which includes known functions, such as, for example, a “file” menu, a “preferences” menu, “help” menu, and a host of other known items. Since such menu items are ubiquitously known to those having skill in the art, only truncated discussions of menu items is provided herein as needed.

FIG. 2 shows an embodiment of presentation software with a GUI for creating slides. When an operator or user wishes to create slides for a presentation, this can be done in one of two ways. In one embodiment, the operator or user selects the slide-maker tab 104, at which point the display window 110 is replaced with another window, referred to herein as a template window 210, which provides an interactive guide for the end-user or operator to create a slide. In another embodiment, the operator or user selects the slide tab 132, which includes a create slide button 260. The selection of the create slide button 260 by the user or operator produces a result that is similar to the user or operator selecting the slide-maker tab 104.

As shown in FIG. 2, irrespective of how the user or operator arrives at the template window 210, the template window provides options to the user or operator to create a slide from a number of pre-defined templates. Additionally, since the display functions are somewhat irrelevant to the slide creation process, the display functions shown in FIG. 1 are replaced with a template toolbar 220, in the embodiment of FIG. 2.

Software for creating slides from templates is well-known in the art, and available in commercial packages such as, for example, MSFT PPT, only a cursory discussion of the slide-making functionality is provided herein. The template window 210 includes various known functions, such as, for example, template properties 230 that permit entry of properties of the slide that is being created, a blank slide button 240 that permits creation of a blank slide without any pre-defined pattern, or a template button 250 that permits creation of a slide from a template, which is further described with reference to FIG. 3.

The slide listing window 120 also includes a show slide function 270 and an add slide function 280. The show slide function 270 expands any listing within the slide listing window 120 to show thumbnails of all of the available slides associated with a particular slide show. The add slide function 280 permits the operator or user to add more slides to any given slide show. Since these functions are also known in the art, further discussion of these functions is omitted herein.

FIG. 3 shows a GUI for creating slides from a template. When a user or operator selects the template button 250 in FIG. 2, a template selection menu 310 is provided for the user or operator. The template selection menu 310 includes one or more predefined templates 312, similar to the templates of other well-known presentation software.

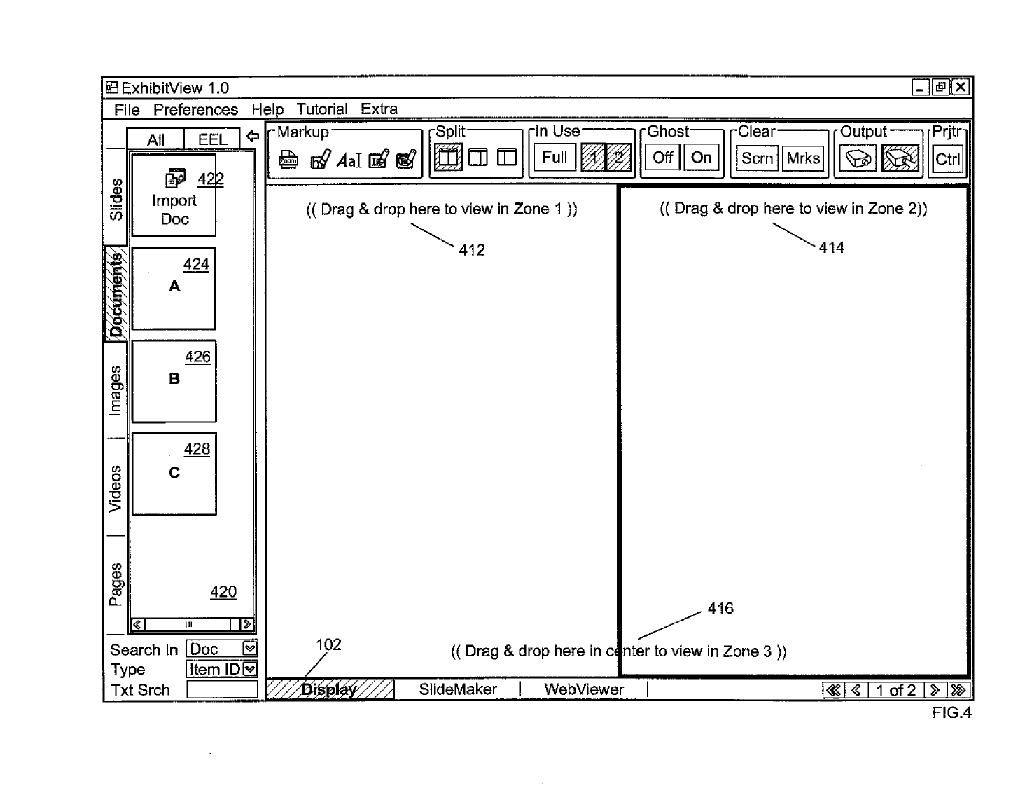

FIG. 4 shows an embodiment of presentation software with a GUI for displaying documents. As shown in the embodiment of FIG. 4, when the operator or user selects the display tab 102, the display window 110 comes to the foreground, along with the corresponding display-related toolbars 130, 140, 150, 160, 170, 180. The display window 110, in some embodiments, is conceptually separated into three separate zones. Namely, Zone 1, which is the left-hand side of the display window 110; Zone 2, which is the right-hand side of the display window 110; and Zone 3, which represents the entire display window 110, For ease-of-use, there is a corresponding on-screen instruction 412, 414, 416 associated with that particular zone. For example, for Zone 1, the on-screen instruction recites that a particular electronic document or file can be selected for display by “dragging and dropping” the file to Zone 1. For some preferred embodiments, these instructions that appear on the display window 110 will not be projected to the projector output. As such, while the user or operator has easy-to-follow instructions that are in plain view on the computer monitor, the audience viewing the output of the projector will not be distracted by these instructions.

FIG. 4 also shows, in greater detail, a document listing window 420, which has an import document button 422, and a listing of all of the documents 424, 426, 428 that are available for display. Should the user or operator wish to increase the available documents for display, the user or operator simply selects the import document button 422, which will result in a dialog box that permits the user or operator to select one or more documents to import into the presentation software. In a preferred embodiment the documents 424, 426, 428 are shown as thumbnails in the document listing window 420. The specific operation of displaying documents is described with reference to FIGS. 6, 7, 8, 9, and 10, below.

For some embodiments, selection of the import document button 422 opens a GUI that permits the user or operator to select a folder in which all of the desired documents are located. The user can select multiple documents, rather than selecting documents one at a time, thereby permitting the user or operator to import more than one document with a single command (e.g., mouse click, etc.). In yet other embodiments, a user may select a folder that comprises different types of documents. In the event that the user or operator selects multiple files, which are of different file types (e.g., doc, pdf, jpg, mpg, etc.), to import, the presentation software for some embodiments can automatically determine the proper location for the different imported files, and auto-populate the corresponding tab area with the files. For example, any selected doc or pdf file will be imported into the document tab 128; any selected img or jpg file will be imported into the image tab 126; any selected mpg file will be imported into the video tab 124; etc. As one can see, this permits a user or operator to easily import documents and sort the imported documents into their respective tab areas with minimal inconvenience. Of course, for file types that are not defined, the presentation software will query the user on which tab area to place the un-defined file type.

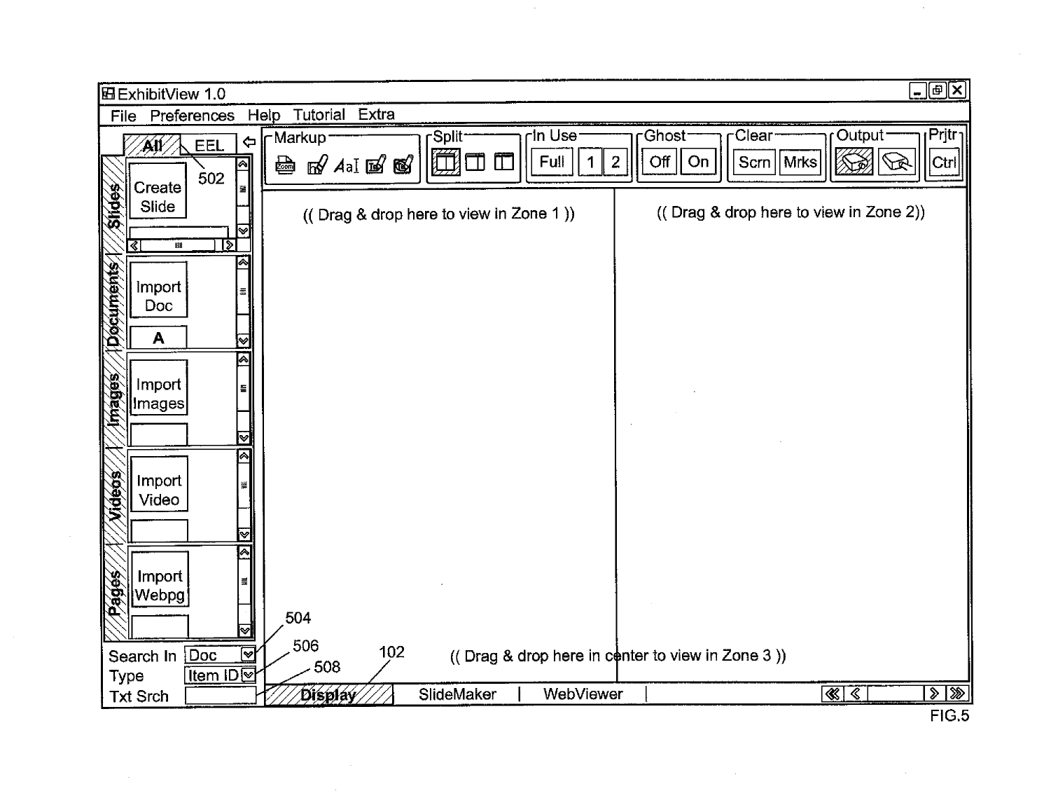

FIG. 5 shows an embodiment of presentation software with a GUI where a user can search for different types of electronic files. As shown in FIG. 5, in some embodiments, the user or operator can choose to view the listing or thumbnails of all available files by selecting a view-all tab 502. Thus, unlike the embodiments described above, which showed a greater portion of one tab (e.g., documents), the embodiment of FIG. 5 shows a smaller portion of all of the tabs. To facilitate finding of documents, the tabs can also include scroll bars, which permit the operator or user to scroll through the listing to find a specific document. In addition to scrolling through the list of electronic files, the embodiment of FIG. 5 also permits the user or operator to find a specific electronic document or file by entering a search location 504, a file number 506, or a searchable string 508 that is located within the electronic file or document. Since search functions are well known, additional discussion of search functions is omitted here.

FIG. 6 shows an embodiment of presentation software with a GUI where a document has been selected for display on one half of a screen. As initially described with reference to FIG. 4, a user or operator selects a document (labeled here as “A” to facilitate understanding of the software), or more accurately the thumbnail of document A, from the document listing window 420. Document A is then dragged-and-dropped into Zone 1, which represents the left-hand side 610 of the display window 110. At this point, the full document A 620 appears in the left-hand side 610 of the display window 110 of the GUI. Substantially simultaneously, the document 620 also appears on the left-hand side of the projector screen (not shown), as described with reference to FIG. 22.

As shown in FIG. 6, a split-screen indicator 602 shows that document A 620 is being displayed on a split screen, and a first-zone in-use indicator 604 shows that document A 620 is occupying only the first zone 610 on the display window 110.

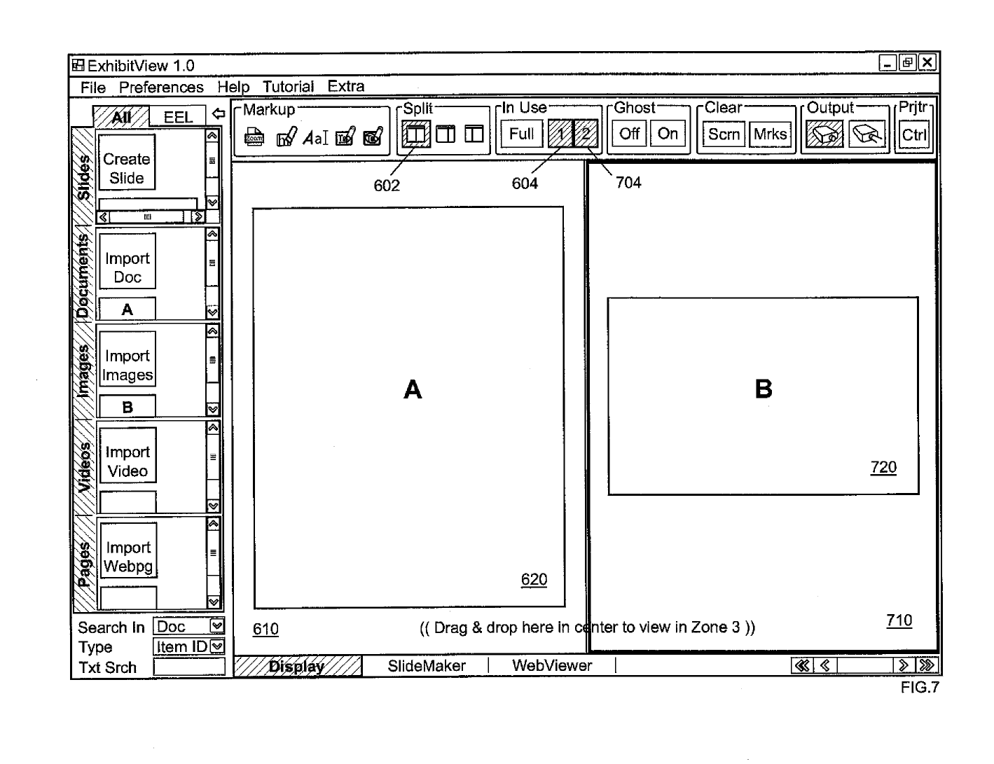

Continuing, FIG. 7 shows an embodiment of presentation software with a GUI where a document and an image have been selected for simultaneous display, each on one half of the total display window 110. In addition to displaying a document 620 in the left zone 610, the user or operator can concurrently display another file or document on the right-hand zone 710 (also referred to herein as Zone 2 or the second zone). In the embodiment of FIG. 7, the user or operator has selected an image file (labeled here as “B”) for display with the document 620. Similar to how the document 620 was selected for display, the user drags-and-drops the thumbnail of image B from the image tab 126 area to the right-hand zone 710, at which point the full image B 720 appears in the right-hand side 710 of the display window 110. Thus, both document A and image B are concurrently displayed, side-by-side, in the display window 110. Now, in addition to the first-zone in-use indicator 604, the second-zone in-use indicator 704 shows that the second zone 710 is in use. As one can guess, the output to the projector will show both document A 620 and image B 720, side-by-side on the projector screen, similar to how it is shown in the display window 110 on the GUI.

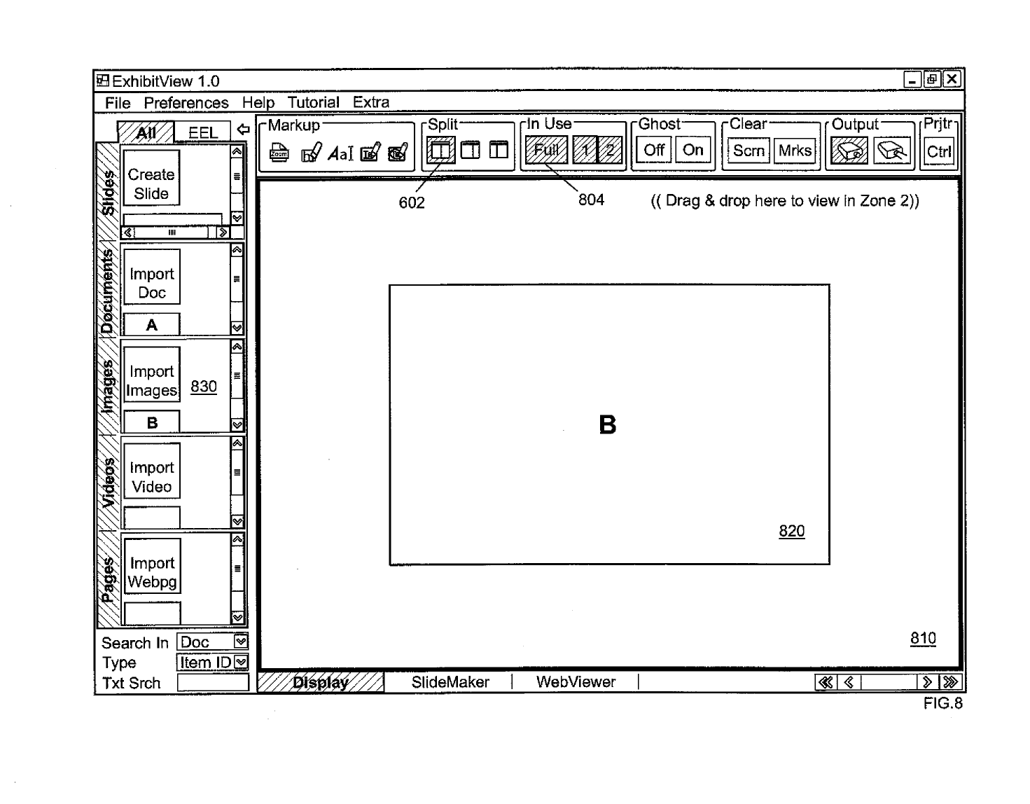

FIG. 8 shows an embodiment of presentation software with a GUI where an image has been selected for display on the full screen. In addition to displaying documents on one side of the screen or the other, the user or operator can occupy the entire display window 110 with a single electronic file or document. By way of example, in the embodiment of FIG. 8, the user or operator selects the thumbnail of image B from the image listing 830 associated with the image tab 126. That thumbnail is dragged-and-dropped into Zone 3 (also referred to herein as the full zone 810), at which point the full image B 820 appears in the display window 110. Here, the full-zone in-use indicator 804 shows the user or operator that the selected document 820, which is being displayed, is occupying the entire display window 110. Again, at substantially the same time, the full image B 820 also appears at the output of the projector (see description with reference to FIG. 22).

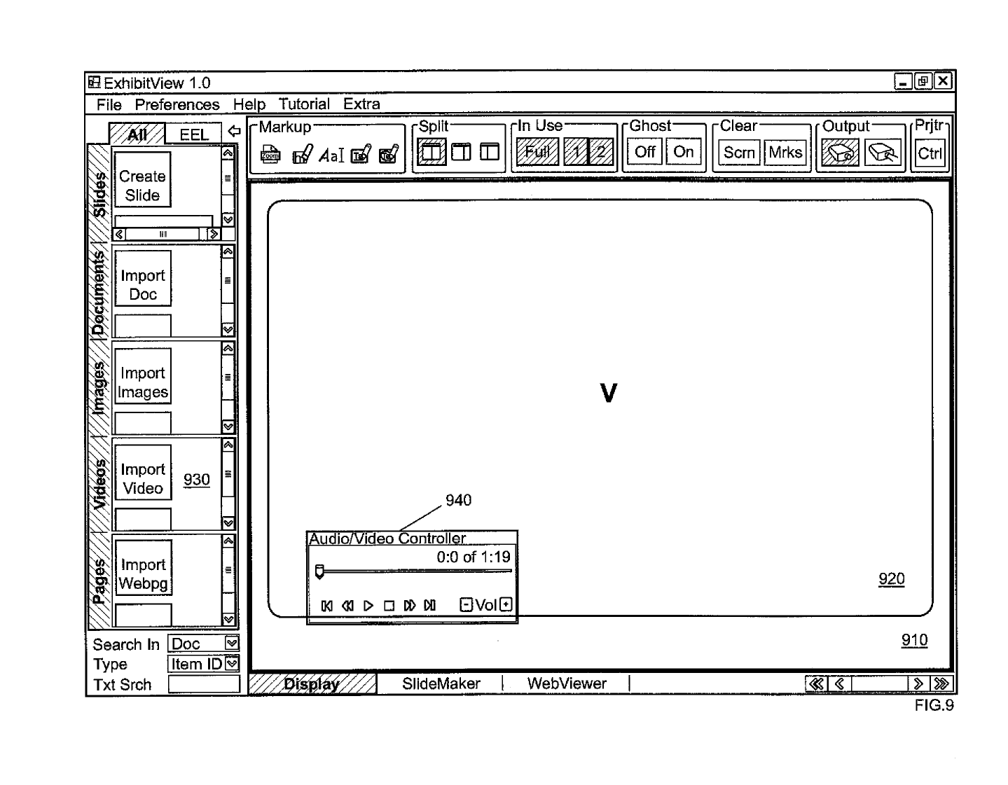

FIG. 9 shows an embodiment of presentation software with a GUI where a video has been selected for display on the full screen. In addition to showing documents and images, some embodiments permit showing of video clips or digital versatile disc (DVD) movies. Similar to the drag-and-drop operation described in FIGS. 6, 7, and 8, the user or operator can select for display an available video clip from a video listing window 930. While the embodiment of FIG. 9 shows a full zone display 910 of a selected video 920, it should be appreciated that the video 920 can be displayed in conjunction with another electronic file or document on a split-screen, similar to what is shown in FIGS. 6 and 7.

When a user or operator drags-and-drops a video 920 to the display zone 910, a video controller 940, such as those known in the art, also appears so that the user or operator can control the play-back and other functions of the video. Since such video controllers are known in the art, further discussion of the video controller 940 is omitted here. It should be noted that while the video controller 940 appears on the GUI, as shown in FIG. 9, the controller 940 is not output to the projector for preferred embodiments. This reduces the distraction to the audience that is viewing the video from the projector output, rather than from the computer GUI.

While not shown in FIG. 9, example embodiments of the video controller 940 will also permit a user or operator to bookmark certain portions of the video 920 so that the user or operator can readily access desired segments of the video. Since the feature of adding bookmarks to videos is known in the art, further discussion of video bookmarks is omitted here.

FIG. 10 shows an embodiment of presentation software with a GUI in which a selected portion of a document is enlarged for display. As shown in the embodiment of FIG. 10, the markup toolbar 130 includes a zoom function 1002. Specifically, FIG. 10 shows a document 1020 that is displayed in Zone 3 1010, with a zoomed portion 1030 that enlarges a portion of the displayed document 1020. In operation, the user or operator selects the zoom function 1002. Thereafter, the user or operator selects a portion of the displayed document 1020 using, for example, a mouse or other selection device. The selected portion is then enlarged and the zoomed portion 1030 is then displayed on the display window. It should be appreciated that the zoomed portion 1030 appears on the projector output at substantially the same time that it appears on the computer monitor. For some embodiments, the zoomed portion 1030 is displayed in a separate window that permits the user or operator to close off the window should the user or operator wish to revert back to the original document 1020 without showing any portion of the document 1020 zoomed.

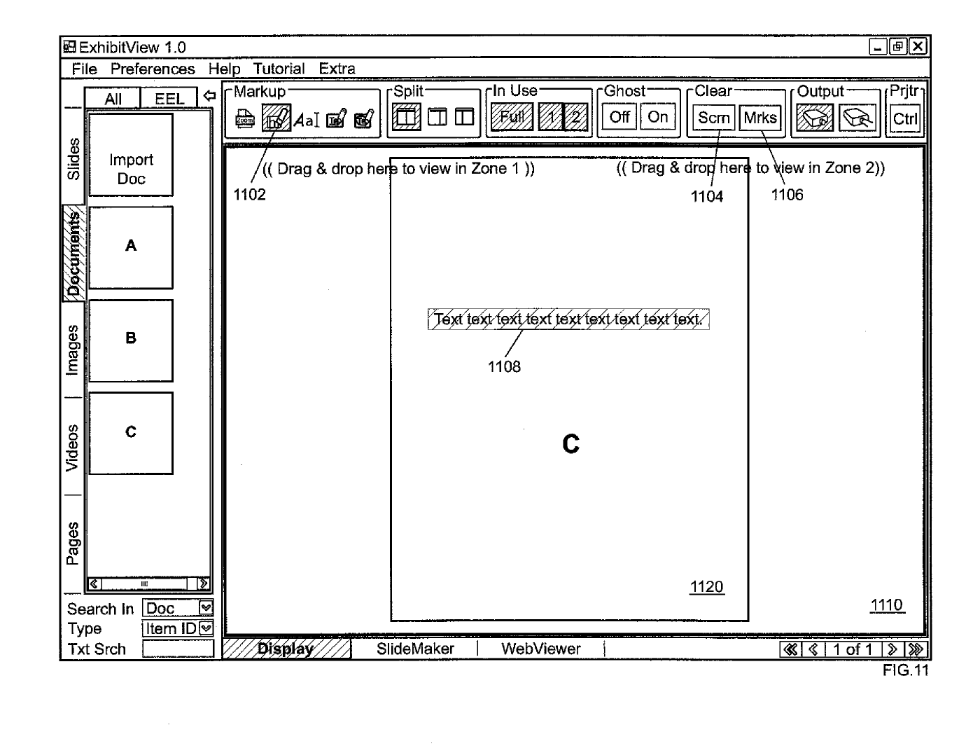

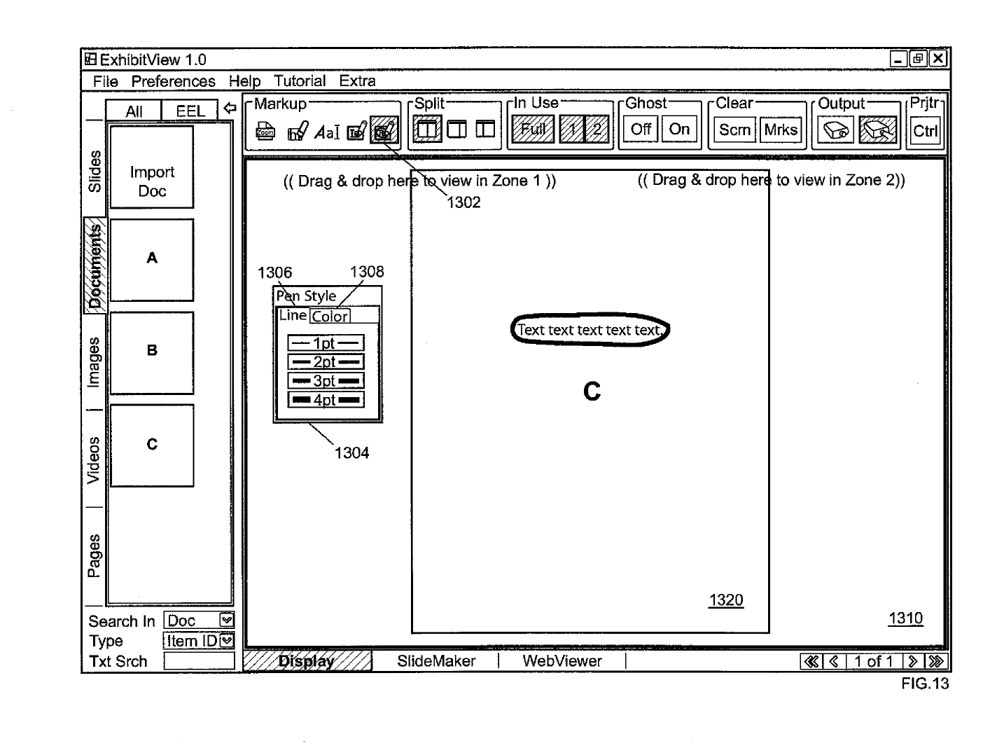

FIG. 11 shows an embodiment of presentation software with a GUI in which a selected portion of a document is highlighted. As shown in the embodiment of FIG. 10, the markup toolbar 130 includes a highlighter function 1102, which permits the user or operator to select a portion 1108 of a displayed document 1120 and emphasize the selected portion 1108. Specifically shown in FIG. 11 is a document 1120 that is displayed on the full screen 1110 (as opposed to split screen, as described above). In operation, the user or operator selects the highlighter function 1102. Thereafter, when the user or operator selects a portion 1108 of the displayed document 1120, the selected portion 1108 appears as if it is highlighted with a predefined color (e.g., yellow, green, etc.). The highlighted portion 1108 can be returned to normal (i.e., without highlight) by selecting the clear-markup button 1106. As described with reference to FIGS. 12 and 13, the clear-markup button 1106 can also be used to clear any underlining or circling or other markup of an electronic file or document. In fact, for some embodiments, the clear-markup button 1106 can also function to close off the zoomed portion 1130.

To digress for a moment, in the embodiments described herein, there are alternative methods for removing an electronic document or file from the display window 110. In one embodiment, a user or operator can simply drag-and-drop the file from the display window 110 back to its respective tab 122, 124, 126, 128, or 132. In another embodiment, a user or operator can simply select another image, document, video, or other electronic file and drag-and-drop it into one of the three zones. For example, in the embodiment of FIG. 7, if the user selects a different document and drags-and-drops it into Zone 2, then that newly-dragged-and-dropped document will replace image B 720. Similarly, if the user drags-and-drops another image into Zone 3, then that newly-dragged-and-dropped image will replace both document A 620 and image B 720, and thereby appear on the full screen.

As shown in FIG. 11, in yet another embodiment, a clear screen button 1104 is provided. Thus, when a user or operator selects the clear screen button 1104, anything that is displayed on the display window 110 is removed from the display window 110 (and correspondingly removed at the projector output).

FIG. 12 shows an embodiment of presentation software with a GUI in which a portion of a document is underlined. Specifically shown in the embodiment of FIG. 12 is an underline function 1202, which can be used to underline 1222 text or other features of an electronic document or file 1220. For simplicity, the document 1220 is shown as being displayed on the full screen 1210. However, it should be appreciated that the underline function 1202 performs similarly for electronic documents or files that are displayed on a split screen, such as that shown in FIG. 7. In operation, when a user or operator selects the underline function 1202 from the markup toolbar 130, a line-properties menu 1204 appears on the computer monitor. The line-properties menu 1204 includes various options that can be changed, such as, for example, line-thickness options 1206 that increase or decrease the thickness of the underline, or line-color options 1208 that permit the user or operator to change the color of the line. The user or operator selects the desired line thickness from the line-thickness options 1206, and also the desired line color from the line-color options 1208. Thereafter, when the user or operator draws a straight line, using a mouse or other input device, the line 1222 appears in the selected line thickness and the selected line color. As noted above, the clear-markup button 1106 is used to remove the underline 1222 when the underline is no longer needed or desired by the user or operator.

FIG. 12 also shows the projector output toolbar 180 with a projector on button 1234 and a projector off button 1232. Specifically, when a projector is operatively coupled to a computer, the projector off button 1232 disables the output to the projector. As such, using FIG. 22 as an example, the projector output 2204 would appear as a blank screen, a black screen, or some other predefined screen that does not reflect what is on the computer display window 110. This function proves useful when the user or operator wishes to minimize or eliminate any documents or files that are on the projector output 2204, which may distract the viewing audience while a presenter is speaking on an unrelated topic. The projector on button 1234 enables the projector output 2204, thereby outputting the contents of the display window 110 to the projector output 2204.

FIG. 13 shows an embodiment of presentation software with a GUI in which a selected portion of a document is circled. Similar to FIG. 12, the embodiment of FIG. 13 is a line tool that permits free-hand drawing of lines. Unlike FIG. 12, the embodiment of FIG. 13 permits drawing of curved or other non-linear lines. This is accomplished through a freestyle markup function 1302, which is located in the markup toolbar 130. In operation, when a user or operator selects the freestyle markup function 1302 from the markup toolbar 130, a line-properties menu 1304 appears on the computer monitor. It should be noted that, for preferred embodiments, this line-properties menu 1304 does not appear on the projector output, and therefore does not distract a viewing audience that sees the projector output, but not the GUI on the computer display. The line-properties menu 1304 includes various options that can be changed, such as, for example, line-thickness options 1306 that increase or decrease the thickness of the freestyle markup, or line-color options 1308 that permit the user or operator to change the color of the line. The user or operator selects the desired line thickness from the line-thickness options 1306, and also the desired line color from the line-color options 1308. Thereafter, when the user or operator draws a freestyle line (such as that shown in FIG. 13) using a mouse or other input device, the freestyle line appears in the selected line thickness and the selected line color. As noted above, the clear-markup button 1106 is used to remove the freestyle markup when the freestyle markup is no longer needed or desired by the user or operator.

It is worthwhile to note that for slides that are displayed, a user or operator can also directly edit the slides while they are in the display window. Thus, for example, should there be a typographical error, the user or operator can simply correct that error while the slide itself is being displayed. Of course, this near-real-time correction on the projector screen will be visible to the viewing audience.

FIG. 14 shows an embodiment of presentation software with a GUI in which two separate documents have been selected for display on a split screen. To simplify the explanation of the split-screen function, the two documents are referred to herein as document A 1420 and document C 1422. As shown in FIG. 14, the split-screen toolbar 140 comprises a first-zone enlarge button 1402. If the first-zone is the left-hand side of the split-zone display 1410, then the first-zone enlarge button 1402 enlarges the left-hand side of the split-zone display 1410. This results in an enlarged document A 1420, while document C 1422 is correspondingly reduced in size so that both document A 1420 and document C 1422 can fit in the display 1410. The output to the projector will also reflect the change in zone size.

FIG. 14 also shows the pointer-off button 1432 and the pointer-on button 1434. Specifically, the pointer-off button 1432 permits a user or operator to place a cursor in the display window 110 without having that same cursor appear at the projector output. Thus, for example, when the user or operator wishes to highlight, underline, or perform another function, the cursor necessarily appears on in the display window 110. Since the human eye tracks movement better than it tracks stationary objects, the movement of the cursor may be a distraction. Thus, to eliminate that distraction, the pointer-off button 1432 prevents the cursor from being displayed at the projector output while still permitting the cursor to be displayed on the GUI at the computer monitor.

In similar fashion, should the user or operator wish to use the cursor to bring attention to a particular portion of the electronic file or document, then the pointer-on button 1434 enables the projector output to display the cursor, such that the user or operator can use the cursor on the projector screen, similar to how one would normally use a laser pointer to bring attention to various portions of a projected image.

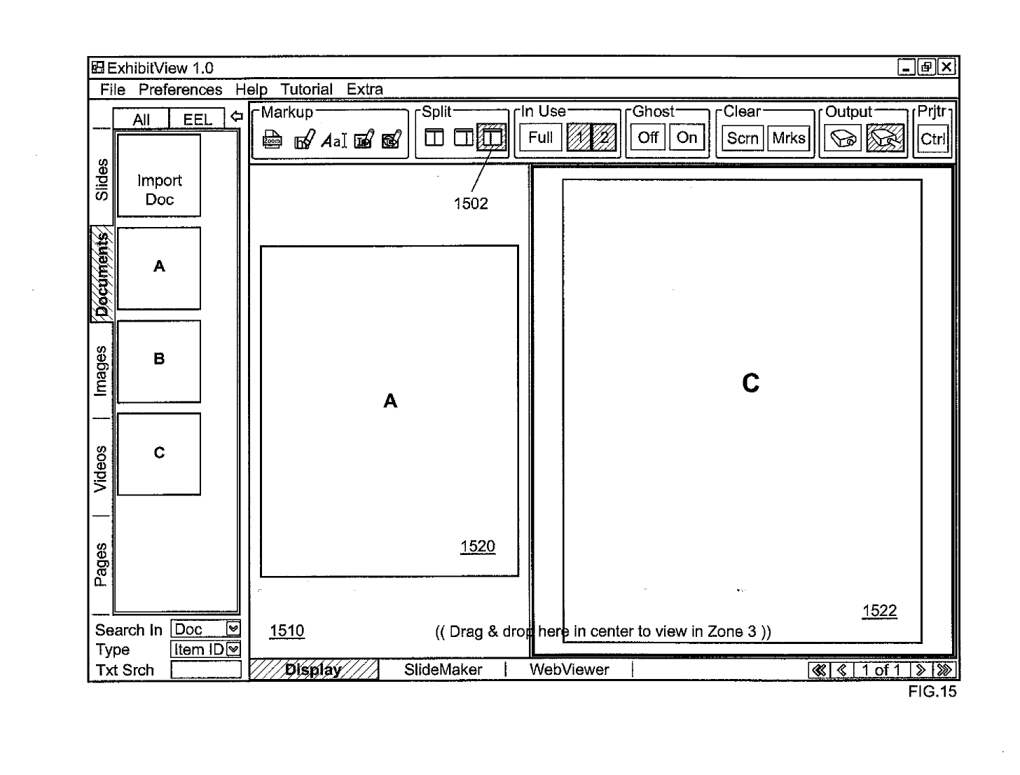

FIG. 15 shows another embodiment of presentation software with a GUI. The embodiment of FIG. 15 is the reciprocal of the embodiment shown in FIG. 14. Namely, rather than having the left-hand document A 1420 be enlarged and the right-hand document C 1422 be reduced in size, the embodiment of FIG. 15 provides a split screen 1510 in which the right-hand document C 1522 is enlarged, and a corresponding reduction occurs with the left-hand document A 1520. Since those skilled in the art can appreciate the reciprocal operation of a second-zone enlarge button 1502 given the description of the first-zone enlarge button 1402 of FIG. 14, no further discussion is provided with reference to the second-zone enlarge button 1502.

FIG. 16 shows an embodiment of presentation software with a GUI in which a web browser located. As shown in the embodiment of FIG. 16, when the user or operator selects the web-browser tab 106, the presentation software automatically changes the GUI to a web-browser by bringing to the foreground the corresponding web-page tab 122. Conversely, when the user or operator selects the web-page tab 122, the presentation software automatically changes the GUI to the web-browser by bringing to the foreground the corresponding web-browser tab 106.

As is known, the web-browser includes an address bar 1602 for inputting or displaying a universal resource locator (URL) address, such as, for example, an Internet address or Internet Protocol (IP) address of a particular website. Thus, for example, if the address <http://www.trialpresentation.net/> is entered as the URL in the address bar 1602, then the corresponding web page 1610 (for simplicity, labeled in FIG. 16 as “E”) is displayed on the display window 110.

The web-page tab 122, when brought to the foreground, shows a web-page listing window 1620, which includes a web import button 1622 and one or more web-page listings 1624. In the embodiment of FIG. 16, the web-page listing 1624 is shown as a thumbnail (labeled as “D”) of the actual web page itself. The GUI also includes a save-page button 1604 (described in greater detail with reference to FIG. 17) and an output-to-screen button 1606. In operation, after a user or operator has navigated to a desired Internet (or other) website, if the user selects the output-to-screen button 1606, then the presentation software outputs the web page 1610 to the projector output for display to the audience.

The web import button 1622 permits a user to import a web page. In operation, when a user or operator selects the web import button 1622, the presentation software displays an input screen or GUI that permits a user to enter the URL of the desired web page. Once entered, the presentation software imports that web-page so that it is displayed in the web-page listing window 1620. For some embodiments, the web-page itself is converted to a Portable Data Format (PDF) file so that subsequent viewing of the web-page will, in reality, be a viewing of the PDF file that has been created from the web-page. As such, thumbnail D, for some embodiments, represents the thumbnail of a PDF file that has been generated from a particular web page.

FIG. 17 shows an embodiment of presentation software where a web page can be saved to a file for later display. As described above, in one embodiment, a web-page can be added to the web-page listing window 1620 by using the web import button 1622. In the embodiment of FIG. 17, once a web page 1610 is displayed in the display window 110, that web page 1610 can be directly converted to a PDF file and saved to the web-page listing window 1620 by selecting the save-page button 1604.

In operation, once the web page E 1610 is displayed in the display window, if the user or operator selects the save-page button 1604, then the presentation software converts the web page E 1610 to a PDF file, and saves that file. That saved file is displayed in the web-page listing window 1620 as a thumbnail 1722 representing the newly-saved web page E. The advantage of converting web pages to PDF files is that it permits broader access to the page, even when the connection to the Internet has been severed. As such, the saved page can be viewed from a computer that does not have direct Internet connectivity. Since the conversion of html (or other web) files to PDF format are known, only a truncated discussion of the conversion process is discussed herein.

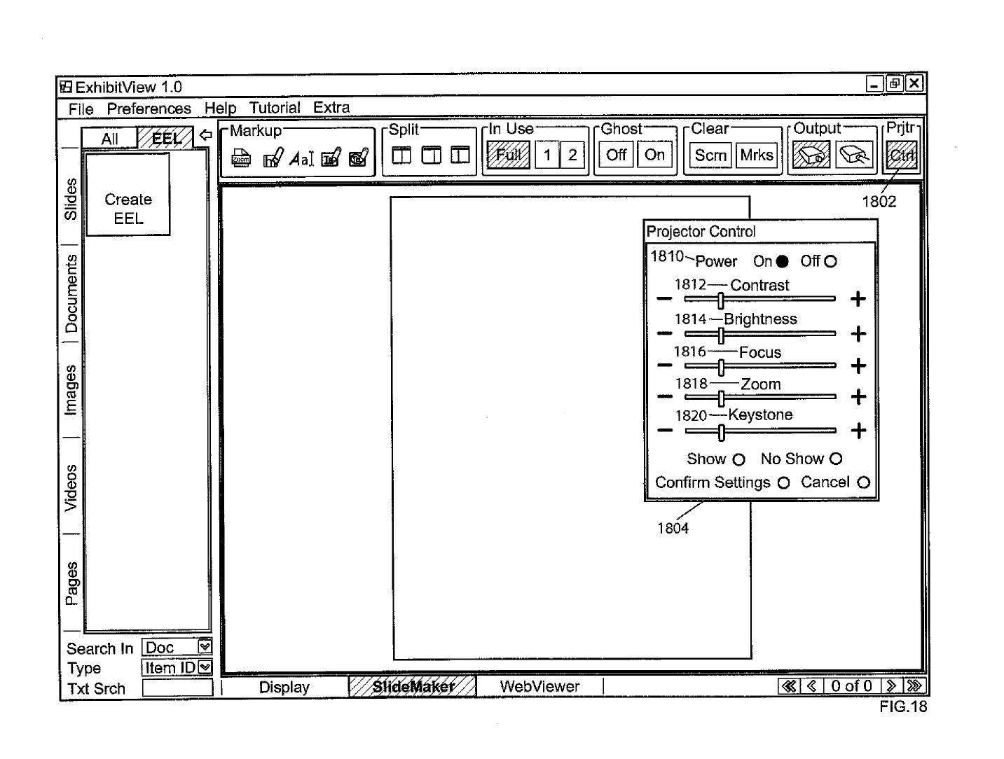

FIG. 18 shows an embodiment of presentation software having control functions for a projector that are accessible from within the presentation software. Conventionally, projector-control software permits a user or operator to control various projector properties (e.g., brightness, contrast, focus, etc.) directly from the computer, rather than requiring the user or operator to physically adjust the knobs or controls on the projector itself. However, if the user or operator is in the middle of a presentation (using, e.g., PPT or TD) and the user or operator wishes to change the brightness of the projector, then the user or operator would typically exit (or minimize) the presentation software and separately open up the projector-control software to adjust the projector properties. Such an interruption can cause a distraction to the viewing audience, especially if the projector controller becomes prominently displayed to the audience at the projector output.

In one embodiment, as shown in FIG. 18, the inventive presentation software remedies this problem by permitting a user or operator to control projector settings without exiting or minimizing the presentation software. This improvement to the presentation software comprises a projector-control icon 1802 accessible from the presentation software GUI. The projector-control icon 1802, when selected by the user or operator, opens up a projector-controller window 1804. While the projector-controller window 1804 is visible on the display window 110 of the GUI, it is not output to the projector. As such, while the user or operator of the computer sees the projector-controller window 1804, the projector-controller window 1804 will be hidden from the viewing audience. It should be appreciated that the projector-control code, which is used to control the projector settings, can be similar to the software that comes standard with the projector itself.

The embodiment of FIG. 18 specifically shows example projector functions, such as power control 1810, contrast control 1812, brightness control 1814, focus control 1816, zoom control 1818, and keystone control 1820. Since these functions are known in the art, further discussion of the projector control itself is not discussed. However, it should be appreciated that the incorporation of these known functions into the presentation software itself will be a marked improvement to conventional software, since it permits an apparently seamless control of the projector, with minimal distraction to the viewing audience.

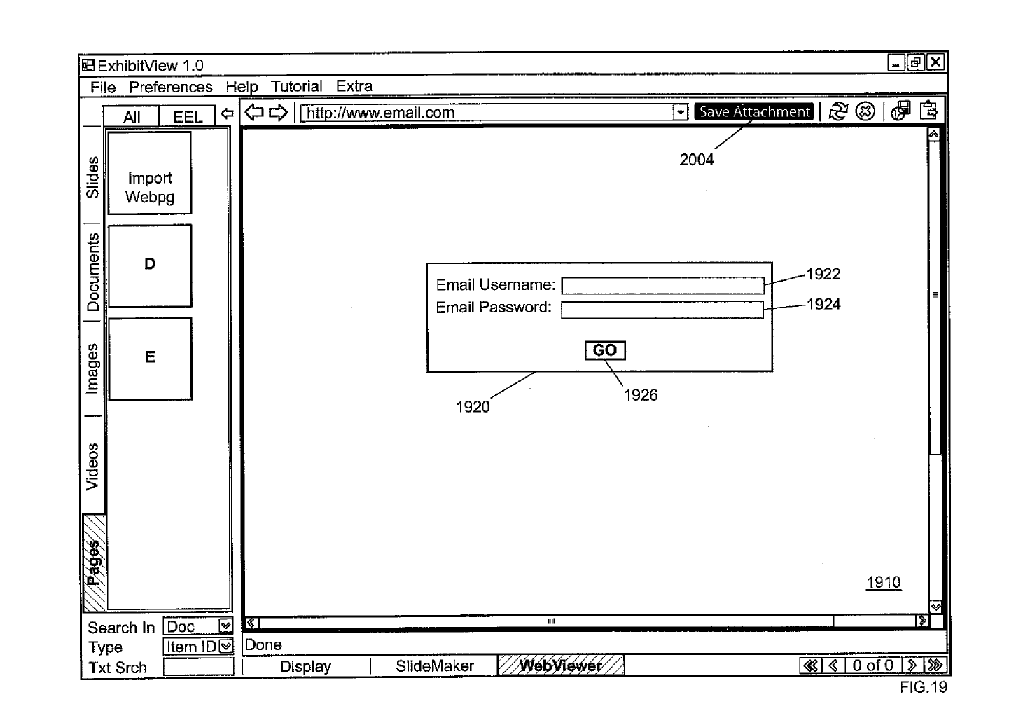

FIGS. 19, 20, and 21 show embodiments of presentation software configured to permit email access from within the presentation software. While the embodiments of FIGS. 19, 20, and 21 show with particularity a web-based email account, it should be appreciated that the web-based email account can be readily implemented by coupling an email client to the presentation software, where the email client accesses email messages that arrive through an email server. Additionally, for other embodiments, the presentation software itself may have its own email address so that any email messages that are sent to the software's email address will automatically appear in one of the tabbed areas 122, 124, 126, 128, or 132.

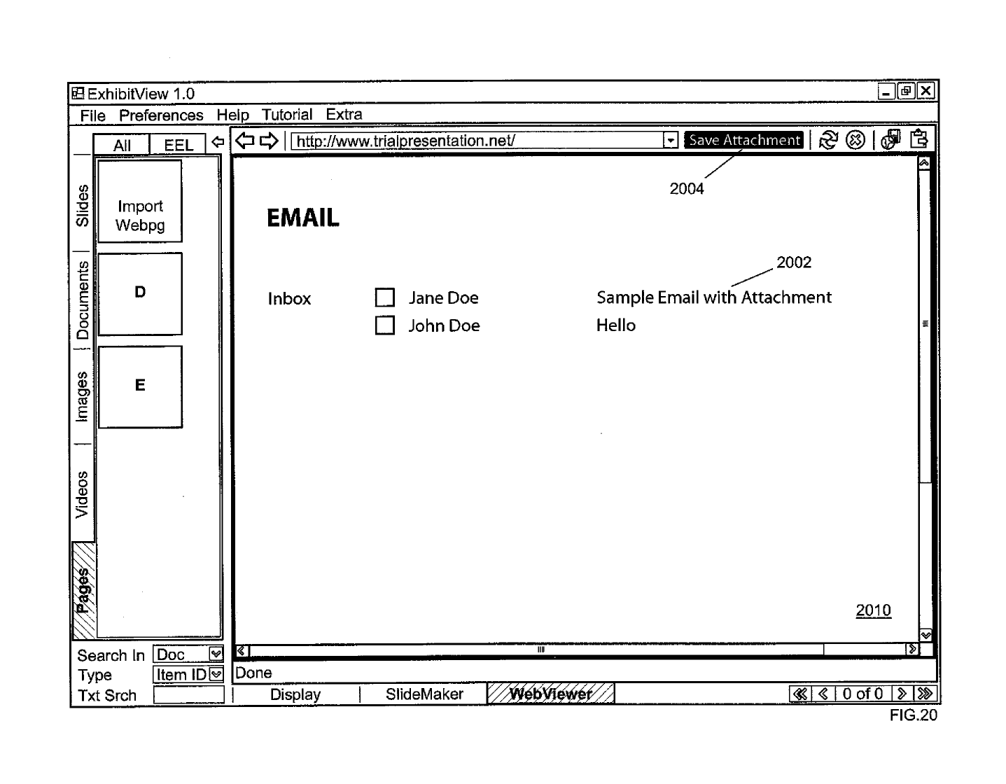

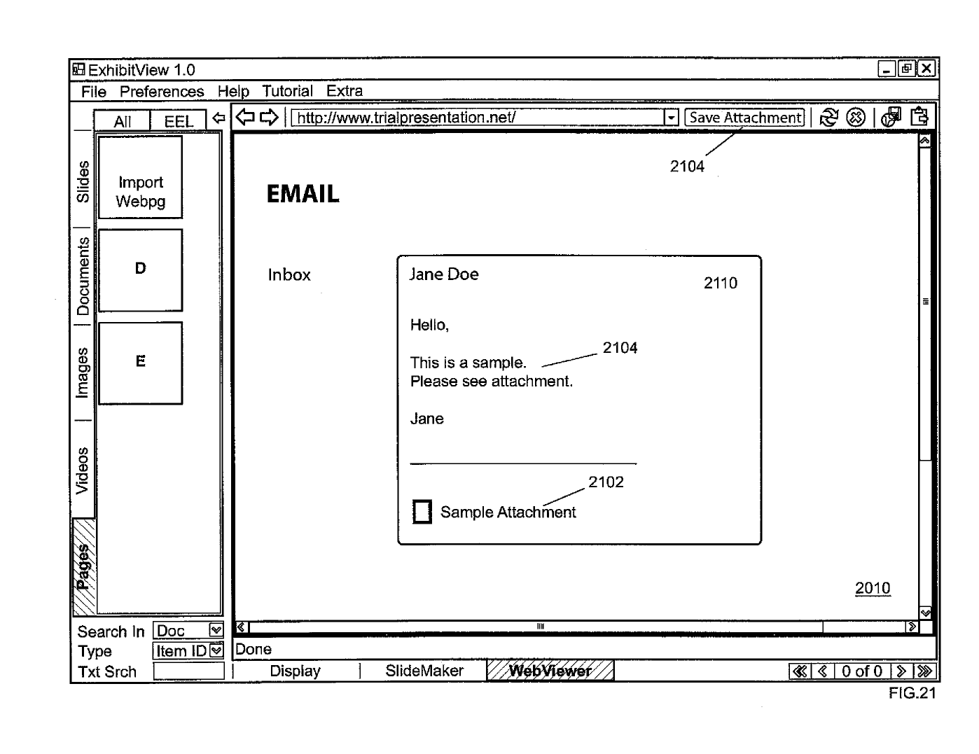

As shown in FIG. 19, when a user or operator enters a web-based email address (shown herein as <http://www.email.com> in FIG. 19) or accesses email from a company website (shown herein as <http://www.trialpresentation.net> in FIGS. 20 and 21), a login screen 1920 is displayed to the user or operator on the display window 1910. As is known, the login screen 1920 includes a login input prompt 1922 and a password input prompt 1924 and, often, a login button 1926. Thus, in operation, a user or operator inputs the login name at the login input prompt 1922, a corresponding password at the password input prompt 1924. Upon the user selecting the login button 1926 (labeled herein as “GO”), the user is logged into his email account.

Continuing, as shown in FIG. 20, once the email account is accessed, the presentation software shows the user's account 2010 in the display window 110. For example, the email inbox of the user is shown in FIG. 20 with two messages 2002, one from “John Doe” and another from “Jane Doe.” When the user selects one of the email messages to view, for example, the “Sample Email with Attachment” from “Jane Doe,” then the display window 110 changes to the email message itself, as shown in FIG. 21.

As shown in FIG. 21, this particular email message 2110 includes the body of the email itself 2104, and an attachment 2102. Since email protocols are well-defined by RFC 2821 and other Internet standards, those having skill in the art will appreciate the email user interface itself without exhaustive detail. Thus, only a truncated discussion of email is provided herein.

Unlike conventional presentation software, the inventive software includes a save-attachment button 2004. When the presentation software determines that an email message includes an attachment, then it provides the user or operator with an option to save that attachment as part of the presentation by selecting the save-attachment button 2004. Thus, in operation, when an email message with an attachment is detected, the save-attachment button 2004 becomes selectable (see difference between FIG. 20 and FIG. 21). Should the user wish to save that attachment as part of the presentation, then the user simply selects the save-attachment button 2004 by using, for example, a mouse or other input device, and the presentation software automatically populates the document list (or other corresponding list) with the newly-saved attachment 2102.

To implement this feature, the presentation software comprises machine-readable code for accessing an email message. As discussed above, the machine-readable code can either be a web-browser, which permits access to web-based email, or the machine-readable code can be an email client that is embedded into the presentation software. The presentation software also comprises machine-readable code for determining whether the accessed email message includes an attachment. As such, when an attachment is detected, then the save-attachment button 2004 becomes selectable by the user. The presentation software also comprises machine-readable code for importing the attachment into the presentation software. It should be appreciated by those in the art that the function of saving email attachments can be handled by script files (or other code), similar to how increased functionality on Internet web browsers can be implemented using scripts such as, for example, Greasemonkey (see, <http://www.greasespot.net>).

One advantage to this email feature is that it permits remote collaboration in preparing presentations. For example, if an attorney is using the presentation software in an Internet-ready courtroom, and realizes that one of the key exhibits is missing from the presentation, then the attorney can simply request his paralegal or assistant to email to him that exhibit as an email attachment. Upon receiving the email message with the needed exhibit as an attachment, the attorney can seamlessly save that missing exhibit to the presentation and continue without requesting a recess or other break in the proceeding.

For some embodiments, the code associated with the save-attachment button 2004 determines the file type that is associated with the attachment, and then automatically saves the attachment to the appropriate file-listing tab or window. For example, if the attachment is an mpeg file, then the presentation software will save the attachment to the video tab 124; if the attachment is a jpeg file, then the presentation software will save the attachment to the image tab 126; if the attachment is a doc file, then the presentation software will save the attachment to the documents tab 128; etc.

For other embodiments, this type of auto-sorting mechanism can be employed for other sorting categories. For example, rather than sorting by file types, the sorting can be done by email sender name. In those embodiments, rather than having “images” or “documents” or “slides,” the tabs would simply be replaced with “Jane Doe” or “John Doe.” Thus, any attachment that arrives in an email from “John Doe” would be saved to the “John Doe” tab; any attachment that arrives in an email from “Jane Doe” would be saved to the “Jane Doe” tab; etc. As one can imagine, the tabs and categories can be custom-tailored to whatever the end-user wishes, such as, for example, dates, project titles, etc. This type of flexibility lends itself to a myriad of applications in the educational field (e.g., teachers sorting homework assignments based on student names), medical field (e.g., doctors sorting patient records according to patient name), legal field (e.g., attorneys sorting trial exhibits according to document type), etc. As one can see, there are a plethora of different fields for which this inventive presentation software can be used.

In addition to the above-mentioned advantages of the inventive software, it should be appreciated by one having ordinary skill in the art that the presentation software can also include code that will automatically correct the alignment of misaligned documents. For example, when a document is scanned to a PDF (or other) file, the document may be rotated during the scanning, thereby resulting in a crooked or misaligned document. Typically, the misalignment manifests itself as a slight rotation, thereby resulting in an on-screen display that seems to be rotated either clockwise or counterclockwise. Given the optical character recognition (OCR) software that is available, it is possible to determine how much the document has been rotated during scanning. Specifically, this is done by determining the linear alignment of the characters on one line of the document, and then comparing that line with the screen raster on the computer monitor. If the document line matches to the raster, then no correction is needed. Conversely, if the line of text is rotated by a certain angle, then the entire document can be counter-rotated to align the text of the document with the screen raster. Similar alignment techniques are used in medical imaging, as well as other fields. As such, one having ordinary skill in the art will appreciate that this type of rotational correction can be done in many different ways. Thus, further discussion of rotational correction is omitted herein.

In a preferred embodiment, the presentation software will be designed with a plug-in architecture, such that the functionality of the presentation software can be increased with modular plug-ins, rather than requiring the entire code to be re-written or revised. Thus, for example, in addition to the above-recited functions, additional features can be added by simply installing third-party software into the presentation software as a plug-in. Since plug-in architecture is well known in the art, and implementation of such architecture will be within the ken of one having skill in the art, details relating to the implementation of such architecture is omitted here.

The code for performing the functions of the presentation software may be implemented in hardware, software, firmware, or a combination thereof. In the preferred embodiment(s), the code is implemented in software or firmware that is stored in a memory and that is executed by a suitable instruction execution system. If implemented in hardware, as in an alternative embodiment, the code can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The presentation software, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations to the invention as described may be made. For example, while a drag-and-drop operation is described extensively herein, it should be appreciated that these functions can alternatively be implemented with a double-click or a single-click of the mouse, or for other embodiments by using a right-click of the mouse. Since single-click, double-click, and right-click functions, in and of themselves, are known in the art, further discussion of those particular functions is omitted herein.

All such changes, modifications, and alterations should therefore be seen as within the scope of the disclosure.

1-8. (canceled)

9. A computer-readable medium having presentation software, the presentation software comprising:
machine-readable code for displaying a graphical user interface (GUI) on a computer monitor, the GUI comprising a predefined display area, the GUI further comprising a function-control area;
machine-readable detection code for detecting whether a projector is coupled to a computer; and
machine-readable output code for outputting, in response to detecting that a projector is coupled to a computer, the predefined display area of the GUI to the projector.

10. The computer-readable medium of claim 9, wherein the function-control area comprises a tab for accessing stored electronic files.

11. The computer-readable medium of claim 10, wherein the tab is associated with an image file.

12. The computer-readable medium of claim 10, wherein the tab is associated with a document file.

13. The computer-readable medium of claim 10, wherein the tab is associated with a video file.

14. The computer-readable medium of claim 9, wherein the display area comprises a first display area and a second display area.

15. The computer-readable medium of claim 14, wherein the first display area and the second display area are substantially similar in size.

16. The computer-readable medium of claim 14, wherein the first display area is larger than the second display area.

17. The computer-readable medium of claim 14, wherein the first display area is located horizontally adjacent to the second display area.

18. An improvement to a presentation software, the presentation software residing on a computer-readable medium, the presentation software having a graphical user interface (GUI) for accessing various functions of the presentation software, the improvement comprising:
machine-readable code for accessing an email message;
machine-readable code for determining whether the accessed email message includes an attachment; and
machine-readable code for importing the attachment into the presentation software.

19. The improvement of claim 18, further comprising:
an icon accessible from the presentation software GUI, the icon for activating the machine-readable code for importing the attachment into the presentation software.

20. The improvement of claim 18, further comprising:
tabbed areas accessible from the presentation software GUI, each tabbed area being associated with a different type of electronic file; and
machine-readable code for identifying a file type associated with the attachment; and
machine-readable code for importing the attachment to the tabbed area corresponding to the identified file type.
